(19) United States
(12) Patent Application Publication
(10) Pub. No.: US 2005/0137017 A1
(43) Pub. Date: Jun. 23, 2005

(54) Electronic gaming system

(75) Inventors: Franz Lechner, Graz (AT); Helmut Steffenini, Graz (AT)

Correspondence Address: NIXON & VANDERHYE, PC, 1100 N GLEBE ROAD, 8TH FLOOR, ARLINGTON, VA, 22201-4714, US

(73) Assignee: Systems in Progress Holding GmbH, Graz (AT)

(21) Appl. No.: 11/006,810

(22) Filed: Dec. 8, 2004

Related U.S. Application Data
(60) Provisional application No. 60/527,774, filed on Dec. 9, 2003.
(60) Provisional application No. 60/527,777, filed on Dec. 9, 2003.

(51) Int. Cl. A63F 13/00

(52) U.S. Cl. 463/42

(57) ABSTRACT

An electronic gaming system comprises a plurality of interconnected data management devices (101a-101n) within a plurality of electronic gaming devices (100a-100n), a databus device (201) for connecting the plurality of data management devices (101a-101n) with each other; and a random value generator for generating a random value (508) within a specified trigger value range (507). One or more of the data management devices (101a-101n) includes a jackpot detection unit (108) for detecting, in a decentralized manner, a current jackpot value (J(t)) after each gaming sequence. A hit event detection unit (108) determines, in a decentralized manner, whether or not the random value (508) generated by means of a random value generator is within a specified hit value range (506).

This application claims benefit and priority of U.S. Provisional Application Ser. No. 60/527,774 filed Dec. 9, 2003 and of U.S. Provisional Application Ser. No. 60/527,777 filed Dec. 9, 2003, and is related to simultaneously-filed U.S. patent application Ser. No. 10/______ (attorney docket: 2789-57) entitled “A DATA MANAGEMENT DEVICE WITHIN AN ELECTRONIC GAMING DEVICE AND A METHOD FOR MONITORING ELECTRONIC GAMING DEVICES”, all the foregoing being incorporated herein by reference in their entirety.

### BACKGROUND

1. Field of the Invention

The present invention relates to an electronic gaming system, and in particular to a system and a method for calculating a random jackpot in an electronic gaming device or in an electronic gaming system comprising a plurality of electronic gaming devices interconnected by means of respective data management devices and a databus.

2. Related Art and Other Considerations

A typical electronic gaming device is preferably electronic in design and operation and has only a few or no electromechanical or mechanical parts for operation. An electronic gaming device may comprise an electronic token acceptor which is designed to accept designated tokens and reject others. Preferably a computer connected to the electronic gaming devices of an electronic gaming system is provided to control and monitor specific electronic gaming devices connected to the computer and to receive data from the electronic gaming devices.

The electronic gaming devices of the present invention may comprise slot machines, a device interfacing card playing tables, roulette tables, dice tables, etc. The electronic gaming system which comprises a plurality of electronic gaming devices interconnected by means of a databus can be a part of a casino system.

A jackpot system used in casinos for allocating the wins from at least one jackpot to players playing at a plurality of gaming positions is disclosed in US Patent Publication US/2001/03/6857. The gaming positions are associated with a computer network including the computing engine having a memory for receiving inputs from the gaming positions and at least one output for communicating information to the players. At least one pay table is stored in that memory or in another memory associated with the computer network. The pay table can be configured by an operator and has a plurality of possible winning entries and wins associated with the winning entries. A selection generator is triggered at least once via the computer network by a trigger input generated in response to the playing of each game of a group of selected games to generate a selection. The selection is compared with the pay table and, if the selection corresponds to a winning entry, the associated win is transferred to at least one player associated with the gaming position which triggered the selection, and/or to another jackpot.

PCT patent publication WO 0 230 532 discloses a method for operating a gaming device comprising at least one roulette basin having a roulette ball circulating therein, a movement sensor which is used to detect the movement of the roulette ball, e.g. the speed or the duration of a revolution thereof; a simulation means for calculating two characteristic moments of the games from the movement data of the movement sensor, e.g. the moment when the roulette ball falls past a specific place and the moment when the roulette ball comes to rest in a field; a generating means used to determine at least one winning value and/or a joker symbol once a signal is received from the simulation means; a gaming value sensor which is used to detect the play value of the roulette basin; a comparison means for comparing the play value with the winning value and/or joker symbol; and, a control means which controls an optic and/or acoustic display in synchronization with the moments calculated by the simulation means and generates a signal corresponding to the result of the means of calculation. The corresponding method and a gaming device for carrying out that method are especially characterized in that the game becomes more attractive by synchronizing the display with the gaming process without forcing the player to change his or her gaming habits.

U.S. Pat. No. 4,283,709 describes a cash accounting and surveillance system for games whereby operation of a number of player operated gaming devices may be monitored for purposes of detecting abnormal operation and/or cheating and for providing automatic accounting information for record keeping and pilferage detection purposes. The system utilizes a node concept, with each node having a non-volatile data storage capability and a communications capability for communicating with each of a plurality of gaming devices coupled to the node. The exemplary embodiment operates in conjunction with slot machines having mechanically rotatable reels and a microprocessor control system for randomizing the reel stopping payouts and other machine functions.

Commonly used electronic gaming devices are connected by a network, e.g. a computer network. The network connection provides many advantages such as the ability to gather gaming data for accounting from the individual gaming devices. Data collection systems are commonly known (e.g. described in U.S. Pat. No. 4,283,709) and provide an operator of an electronic gaming system with the capability to monitor the usage and payouts, collectively known as audit data. This audit data includes data related to the money (cash and cashless) played, the number of times the device has been played, the amount paid in raises, the number and type of the jackpots paid by the machine, the number of door openings, etc. The operator is able to compile an accounting report based on the audit data from each of the electronic gaming devices.

Another advantage of the connection of electronic gaming devices via a computer network is the usage of the audit data for marketing purposes. Marketing and management of electronic gaming devices is based on the provision of statistical data of specific electronic gaming devices, e.g. slot machines. Thus the data have to be collected in regular periods, have to be stored, processed and optionally displayed. If a network is provided, the operator can easily operate the operation of the specific electronic gaming devices from a remote location.

In order to implement jackpot gaming systems, the electronic gaming devices have to be interconnected via a computer network to attract the players' interest. A relatively large number of different jackpot and bonus systems implemented requires data management to handle and operate these systems.

For example, data used for the above mentioned purposes usually are generated in various acceptors and meters (e.g. coin acceptor, bill acceptor, . . . ) whereas additional data are gathered from door openings, hand payouts, jackpot payouts, display systems etc.

It is necessary that most of the data be collected, stored, processed and explored. This is why data have to be communicated from the location where they are generated to the location where they can be processed and have to be provided for the operator. Such a data management and communication require stable data management systems.

FIG. 5 illustrates a conventional electronic gaming system. A number n of electronic gaming devices 301a-301n are connected via a communication network device 309. Data from particular electronic gaming devices 301a-301n are transferred to and stored in a central database 304 which is usually provided twice (for, e.g., redundancy). A floor server 401, usually provided redundantly, connecting the central database 304 with the communication network device 309. A computer 308, e.g. a workstation for configuration purposes, is connected to the central database 304. The floor server 401 comprises a data concentrator for concentrating data and three operating servers 305, 306 and 307 serving, e.g. as an accounting server 305, a clearance server 306 and a journal server 307, respectively. Furthermore, a display controller 311 is connected to the communication network device 309 for displaying gaming data at a display device 310.

Each of the electronic gaming devices 301a-301n comprises an interface controller 302a-302n for communicating data to and from the communication network device 309. In the conventional electronic gaming system shown in FIG. 3 gaming data are forwarded to a central database 304. The electronic gaming devices 301a-301n each communicate (via the interface controller 302a-302n) with a casino operator, a control processor unit for the electronic gaming device, a data concentrator, and a propriety user interface to export the data.

It is thus a major disadvantage of a conventional electronic gaming system that at least three independent communication interfaces have to be provided, and that in case of total redundancy each communication interface has to be built up twice for each electronic gaming device, because each communication interface is to be regarded as a source of failure. In case of a breakdown of a singular communication interface device the data management system becomes instable. Thus, each single failure can destroy a secure communication between the operator and a specific electronic gaming device.

Jackpots are widely used in gaming sites to attract players and maintain them enjoying the electronic gaming devices. During a jackpot gaming sequence, a gaming sequence at a specific location permits the placement of an extra bet at the time of placing the normal bet for a site game. If the player obtains a predetermined set of events, the player hits the jackpot and wins. A jackpot is progressive if it increases in value as players contribute to it by participating with an extra bet from one gaming sequence to the next. The extra bet is determined by a fixed percentage, i.e. an increment percentage. These jackpot gaming systems are designed to be progressive.

It is a major disadvantage of conventional electronic gaming devices featuring a jackpot system which is triggered by the electronic gaming device itself, that the hit values as well as the hit frequencies are less controllable, typically being based on the gaming history.

Furthermore, it is a disadvantage of conventional electronic gaming systems featuring a jackpot system which is triggered by the electronic gaming system that players at different locations cannot participate in a joint jackpot system by a single gaming sequence being performed in a specific electronic gaming device due to technical limits regarding requirements in communication bandwidths and corresponding computing performance.

Furthermore, it is a disadvantage of conventional electronic gaming systems that a large number of different gaming devices at different sites cannot be connected in order to actually exchange gaming data.

Disadvantageously, electronic gaming devices of conventional electronic gaming systems have to communicate audit data of each gaming sequence to a central location in order to process the data, generate a trigger event in a random manner, and compare the trigger event with the hit preconditions. It is a disadvantage that, after processing and comparing of the data, the results have to be communicated back to the specific electronic gaming device. The whole communication has to be performed in real time, which means that the reaction to a stimulus has to be provided within a certain time, i.e. between two gaming sequences at a specific electronic gaming device. This interval usually has to be shorter than 1 or 2 seconds. In order to meet these communication requirements, it is a disadvantage that a broad communication bandwidth and a large computing power are required.

It is a further disadvantage of conventional jackpot systems triggered by the electronic gaming device that a predictability of a hit event can be carried out by the player as the gaming sequence of a first electronic gaming device only depends on the specific electronic gaming device and not on other electronic gaming devices connected to the first electronic gaming device via a communication network.

Especially when electronic gaming devices of different locations (sites) are connected, the requirement of broad communication bandwidth is inexpedient.

Disadvantageously a conventional jackpot system cannot be operated at various sites due to various factors. A first such factor is a technological limit given by communication technologies and communication bandwidths (since data have to be transferred to one central location in a real time way, have to be processed, and have to be transferred back to the respective electronic gaming device). If electronic gaming devices at different sites are connected, a fulfillment of these requirements with respect to communication technologies cannot be ensured. A second such factor is a technological limit given by the required computing power, which is determined by a linear increase with increasing communication bandwidth. A third such factor is an insufficient reliability of the system if the communication line between a central site and the connected external site is damaged.

### BRIEF SUMMARY

It is thus an object of the present invention to provide an improved electronic gaming system and a method for operating the electronic gaming system device in a more reliable manner.

An electronic gaming system comprises interconnected electronic gaming devices and a jackpot which is triggered by the system. If the jackpot is triggered by the system a specific and defined procedure can be provided for a determination which electronic gaming device is hitting the jackpot.

The inventive electronic gaming system comprises a plurality of interconnected data management devices within a plurality of electronic gaming devices. A databus device connects the plurality of data management devices with each other. A random value generator generates a random value within a specified trigger value range. One or more of said data management devices include a Jackpot detection unit for detecting, in a decentralized manner, a current Jackpot value after each gaming sequence. A hit event detection unit determines, in a decentralized manner, whether or not the random value generated by means of the random value generator is within a specified hit value range.

Each data management devices has a processor unit for processing gaming data generated in the respective electronic gaming device in response to a gaming sequence being performed using the electronic gaming device; a memory unit for storing gaming data generated in the gaming device, by means of the processor unit; and a communication device for communicating gaming data with at least one other data management device within the other electronic gaming device of said electronic gaming system.

The databus connects to the communication devices provided in each of the data management devices for exchanging gaming data between said data management devices of said electronic gaming system; and

A method for monitoring a plurality of gaming devices interconnected by the means of data management devices in an electronic gaming system comprises:
generating a random value within a specified trigger value range (using, e.g., a random value generator provided by the electronic gaming system);
detecting a current Jackpot value, in a decentralized manner at one or more of the data management devices, after a gaming sequence has been performed in one ore more of the electronic gaming devices (using, e.g., a Jackpot detection unit of an data management device); and
determining, in a decentralized manner at one or more of the data management devices, whether or not the random value is within a specified hit value range (using, e.g., a hit event detection unit).

The foregoing actions may occur in the context of an overall operation scheme which further comprises:
processing gaming data generated in an electronic gaming device in response to a gaming sequence being performed using the gaming device by means of a processor unit provided in the data management device;
storing gaming data generated in the electronic gaming device in a memory unit provided in the data management device, by means of the processor unit;
communicating gaming data with at least one other data management device of said electronic gaming system by means of a communication device provided in the data management device;
storing said gaming data of said other electronic gaming device in the memory unit of the data management device by means of the processor unit; and
processing gaming data stored in said memory unit by the processor unit of the data management device;

Advantegously each gaming sequence performed at one or more of the electronic gaming devices are located in different sites contributes to an increase of the Jackpot value.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 is a schematic view of a data management device within an electronic gaming device according to an example embodiment.

FIG. 2 is a schematic of an electronic gaming system comprising a plurality of data management devices within electronic gaming devices interconnected by means of a databus, according to an example embodiment.

FIG. 3 is a schematic view illustrating modification of a jackpot value in accordance with gaming sequences performed in one or more electronic gaming devices depending on gaming duration.

FIG. 4 is a flowchart depicting base, example steps in a method for operating an electronic gaming system according to an example embodiment.

FIG. 5 is a schematic view of a conventional electronic gaming system.

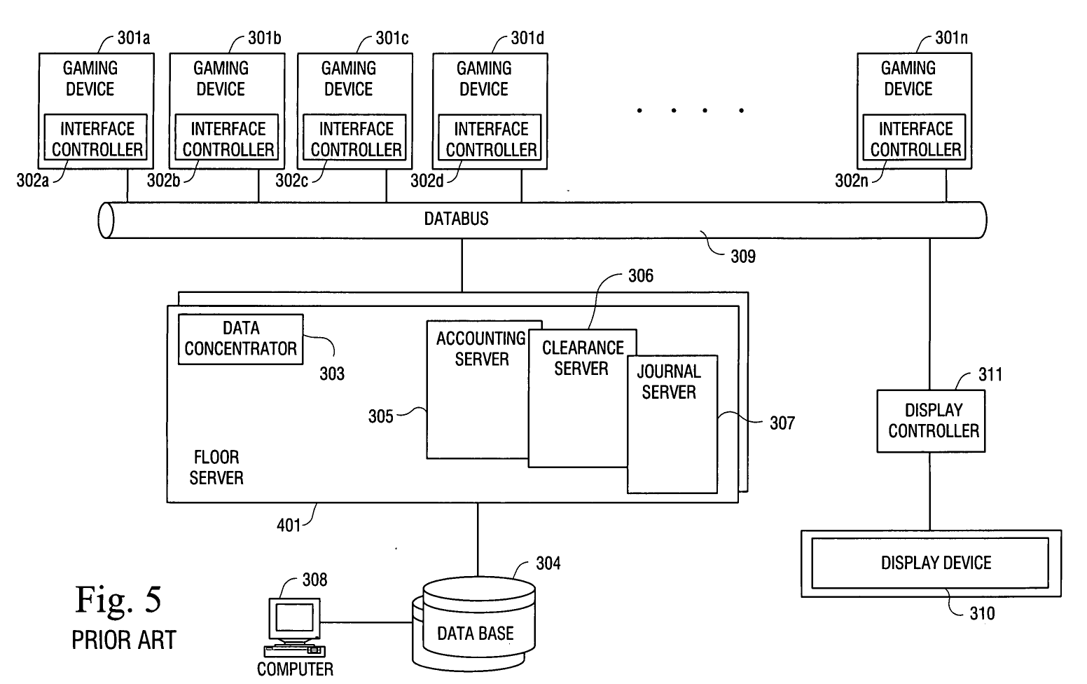

### DETAILED DESCRIPTION

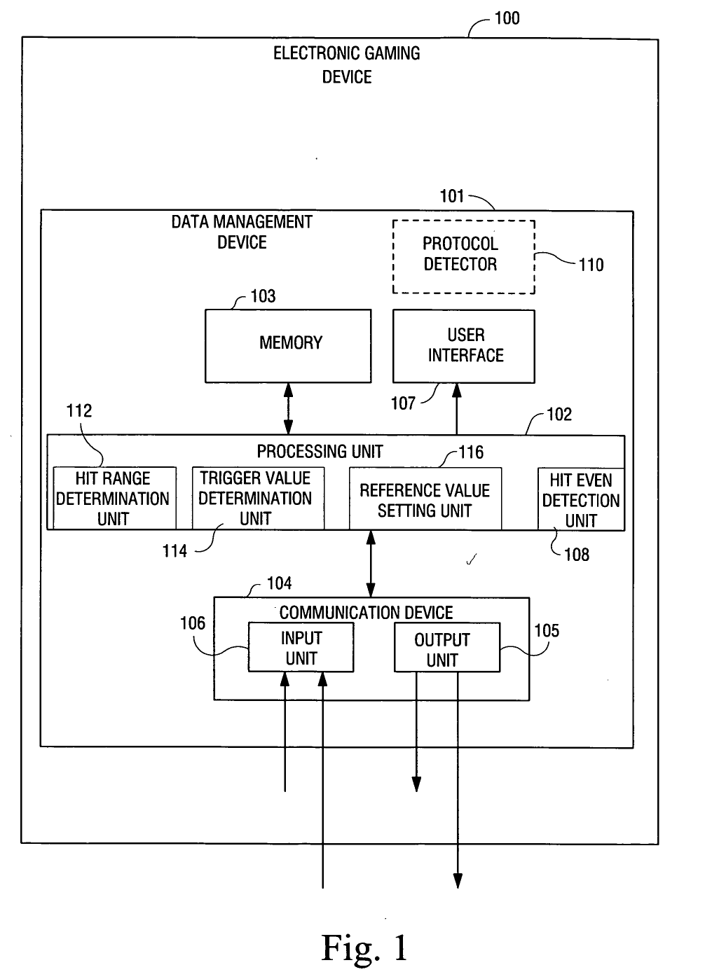

FIG. 1 shows a schematic block diagram of an electronic gaming device 100 according to an example embodiment. The electronic gaming device 100 of FIG. 1 comprises a data management device 101 as a central processing unit and a processor unit 102 which includes a hit event detection unit 108. The processor unit 102 is connected to a memory unit 103 and (optionally) to a user (human, e.g., player) interface unit 107. The user interface 107 comprises one or more of a display unit for displaying gaming data, a player identification unit for gathering player related information, an input unit for communication purpose between the player and the electronic gaming system, and other peripheral devices.

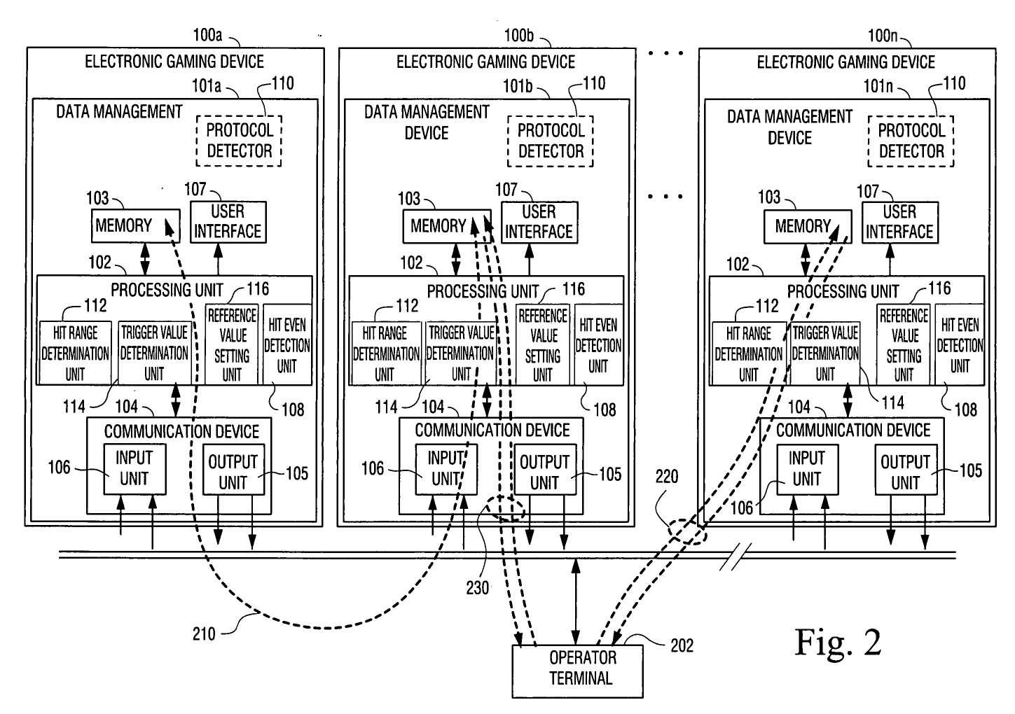

The processor unit 102 is adapted to store gaming data into the memory unit 103 and to read gaming data from the memory unit 103. Furthermore, the processor unit 102 is connected to a communication device 104 which is designed for communicating gaming data with at least one other data management device connected to an electronic gaming system. The electronic gaming device 100 is one of a network of interconnected electronic gaming devices 100a-100n (to be described with reference to FIG. 2) of the electronic gaming system.

The communication device 104 essentially consists of an output unit 105 and an input unit 106. The output unit 105 outputs gaming data to an external device e.g. to another data management device 101a-101n of the electronic gaming system. The input unit 106 inputs control data and external data from the external device (from another data management device 101a-101n) such that these data can be transferred to and stored in the memory unit 103 by means of the processor unit 102.

Furthermore, it is possible to provide serial or parallel interfaces for the connection of the communication device 104 and a corresponding electronic gaming device 100 and a one to many communication to the databus device 201 (FIG. 2). In an example embodiment all data management devices 101a-101n within electronic gaming devices 100a-100n include a communication device 104 such that they are able to communicate via serial connections of some type using a protocol of some type typical for a brand of an electronic gaming device (e.g. a slot accounting system; SAS protocol). In the example embodiment the communication device 104 is located within the data management device (i.e. the slot machine interface board) which basically provides the interface between the electronic gaming device and the operator. Furthermore, it is possible to provide serial or parallel interfaces for the connection of the communication device 104 and a databus device 201 (FIG. 2). In a preferred embodiment of the present invention all data management devices 111a-101n include a communication device 104 such that they are able to communicate via serial connections of some type using a protocol of the some type typical for a brand of an electronic gaming device (e.g. a slot accounting system; SAS protocol). In the preferred embodiment the communication device 104 is located within the data management device (i.e. the slot machine interface board) which basically provides the interface between the electronic gaming device and the operator.

A hit event detection unit 108 is provided in the processor unit 102 for the detection of hit events in said electronic gaming device 100. Thus each data management device within the electronic gaming device is capable of detecting a hit event independently of another electronic gaming device. Each data management device 101a-101n further comprises a hit value range determination unit 112; a trigger value range determination unit 114; and, a reference value setting unit 116. The data management devices, and/or one or more of the units comprising the same, may be realized by individual hardware circuits, using software programs and data in conjunction with one or more suitably programmed digital microprocessors or general purpose computers, using application specific circuitry (ASIC), and/or using one or more digital signal processors (DSPs). Furthermore, it should be realized that structures or functionalities (e.g., routines or calculations) corresponding to some or all of these units can be combined or distributed in divers manners.

FIG. 2 illustrates an example embodiment of an electronic gaming system comprising a plurality of data management device 101a-101n within electronic gaming devices 100a-100n interconnected by means of a databus device 201. Furthermore, FIG. 2 shows an operator terminal 202 which is provided for an operator to control and monitor one or more of the electronic gaming devices 100a-100n. Furthermore, it is possible to provide an interface for the connection of the communication device 104 and a databus device 201 (FIG. 2).

In an example embodiment all electronic gaming devices 100a-100n include data management device (i.e. the slot machine interface board) 101a-101n, including a communication device 104 such that they are able to communicate with each other. In the preferred embodiment a data management device 101 is located within the electronic gaming device and basically provides the interface between the electronic gaining device and the operator.

Gaming data relevant to control, to operate, and to monitor the electronic gaming devices 100a-100n are communicated to the specific communication device 104 of data management device 101a-101n. Gaming data from one electronic gaming device 100a thus may be transferred to one or more of the remaining data management devices 101b-101n within the remaining electronic gaming devices 100b-100n via the communication devices 104. The respective processor unit 102 of a data management device is able to transfer external data from other data management devices 101b-101n within other electronic gaming devices 100b-100n to the memory unit 103 of the data management device 101a.

In an example embodiment a data management system periodically synchronizes the data stored in the memory units 103 of the data management devices 101a-101n in order to ensure that the data in the respective memory units 103 of the data management devices 101a-101n are consistent data. Preferably all the gaming data stored in one data management device 101a of one electronic gaming device 100a are transferred to all other data management devices 101b-101n in all other electronic gaming devices 100b-100n.

The databus device 201 connecting the plurality of data management devices 101a-101n by means of communication devices 104 may be provided as a one to many communication. Furthermore, it is possible to provide the databus device 201 as a 100 BaseTBus. Furthermore, it is possible to provide the databus device 201 as an Ethernet/or Internet connection.

The gaming data exchanged between the data management devices 101a-101n within the electronic gaming devices 100a-100n roughly can be divided into two different groups: (i) static data; and (ii) dynamic data.

The static data are data that are strictly correlated to the data management devices 101a-101n of a respective electronic gaming device 100a-100n. The static data cannot be changed and are not suited for data processing in another data management device 101a-101n. Thus, the static data specifically correspond to one single data management device 101a-101n.

The static data comprise position identification data, parameter data (parameters of the electronic gaming device); and, automatic parameter data. The position identification data can be a position identifier and thus can be equivalent, for example, to an IP address of the data management device 101a-101n. In an example embodiment the position identifier may be alphanumeric. Furthermore the position identifier can be a function of different groupings as there may be, e.g., bank, area, site name, game, etc. or a combination of these. Furthermore the position identifier can be the IP Address of the electronic gaming device in the network.

The parameter data of an electronic gaming device 100a-100n are manually input into the data management device 101a-101n. The electronic gaming device 100a-100n does not provide any information about these data via a protocol. Examples for these data are inventory numbers, manufacturer names, model names, cabinet style, etc.

The automatic parameter data for electronic gaming devices 100a-100n are communicated from the electronic gaming device automatically via a protocol. Examples for these data comprise denomination data defining the relation between currency units and gaming units, maximum-bet data defining a possible maximum bet during a game sequence, payout percentage data, serial number data, game identification data, pay table identification data, bill country code data, data relating to the number of games implemented, etc.

The above mentioned dynamic data comprise data which are communicated from one electronic gaming device 100a-100n to the data management device 101a-101n and to the other data management devices 101a-101n, these data being transferred by each communication device 104.

The dynamic data comprise: site configuration data; jackpot configuration data; and audit data. The site configuration data defines the characteristics of the site and operation characteristics; for example, these data include a site name, a site short name, a day closing period, a clearance period, etc.

The jackpot configuration data includes all data required to define jackpot systems, e.g., jackpot name data, jackpot type data, jackpot parameter data, etc. The audit data are related to a respective gaming sequence performed at the electronic gaming device and which are related to in situ maintenance data. These data are generated by the specific electronic gaming devices 100a-100n. These data include, for example, the amount of funds (cash and cashless) being wagered, the number of times the electronic gaming device 100a-100n has been used, the number and type of the jackpots played by the electronic gaming device, the number of door openings, etc.

An example, representative procedure for exchanging data between the data management devices 101a-101n via the databus device 201 is described below.

When an electronic gaming system with its respective data management devices 101a-101n and its communication devices 104 is set up, the operator initially assigns identification data and configuration data to each data management device 101a-101n. These data comprise static data and initial dynamic data. The operator utilizes a standard web browser to assign all required information to the respective data management devices 101a-101n by the means of the communication devices 104.

The operator assigns static data comprising the position identification data of a specified data management device 101a-101n at a specified location. In the electronic gaming system the position number (position identifier) of a data management device 101a-101n including a communication device 104 can be used as the IP address of the data management device 101a-101n. Furthermore, the user assigns the parameter data of the electronic gaming device.

The automatic parameter data of the electronic gaming devices are communicated automatically by the electronic gaming devices 100a-100n to the respective data management device 100a-100n via the respective communication devices 104. It is possible that different manufacturers of electronic gaming devices utilize different protocols for a communication. Therefore, the data management device 101 comprising the communication device 104 has a protocol detector 110 which starts an automated scanning procedure with the purpose to identify the protocol of the electronic gaming device. The data management device 101 comprising the communication device 104 is capable of automatically identifying protocols of most of the relevant brands of electronic gaming devices 100a-100n.

For assigning the initial dynamic data the operator connects a specific data management device 101a-101n to the databus device 201. The identification of the communication device 104 of the data management device 101a-101n to be connected is performed by entering the IP address and/or the position identification data.

The data management device 101 comprising the communication device 104 being automatically connected obtains a server function for a specific data set. This means that the data management device 101 having the server function transfers required data to any other data management device 101a-101n if requested unless the server function is switched off due to a failure or due a removal of the specific data management device 101a-101n or the specific electronic gaming device 100a-100n. In this case a specified procedure starts to determine a new data management device 101 of another electronic gaming device 100a-100n for getting the server function to correlate the specific dataset.

During an operation of the electronic gaming devices 100a-100n comprising the data management devices 101a-101n connected by the databus device 201 audit data are related to the gaming sequence, i.e. meter readings, gaming data and jackpot data and furthermore are related to the maintenance of the electronic gaming device, e.g. door openings. Those data are communicated from the electronic gaming device to the communication device 104 of the data management device 101a-101n via a protocol. Each data management device 101a-101n processes, stores and transfers audit data in regular time intervals.

Furthermore, audit data may be transferred to the operator terminal 202 when requested. As the audit data are transferred to the databus device 201 it is possible to display relevant data at a display system preferably comprising a data management device comprising a communication device and a display device (not shown)

Furthermore, data may be processed in each data management device 101a-101n by means of a respective processor unit 102. Thus, the processor unit 102 is designed to handle various jackpot data as defined by the operator.

The electronic gaming system according to a preferred embodiment of the present invention comprising a plurality of data management devices 101a-101n within electronic gaming devices 100a-100n permits gaming sequences to be performed using a jackpot system.

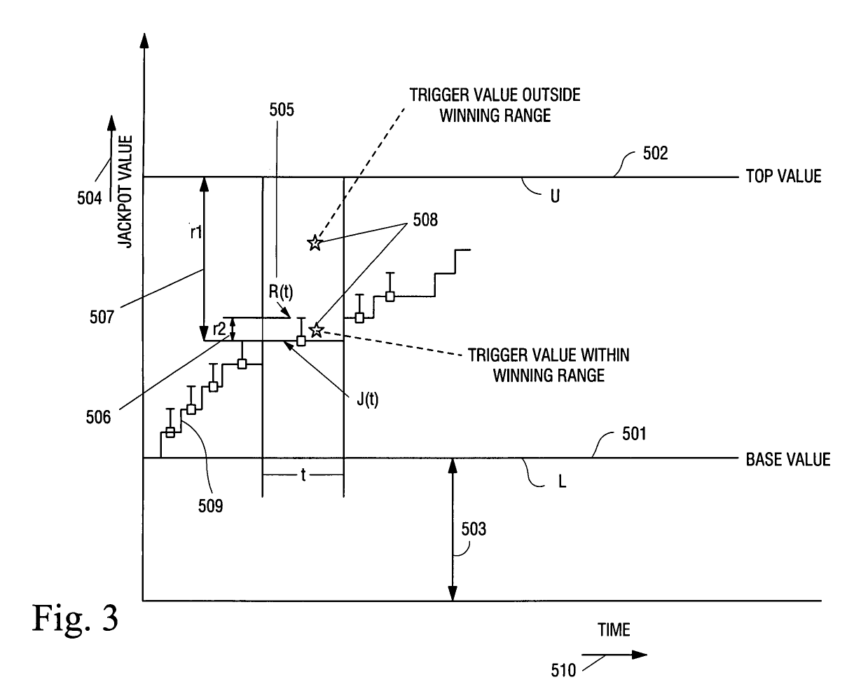

FIG. 3 shows determination of a jackpot value 509 in dependence of the gaming sequence duration 510. A lower limit 501 and/or an upper limit 502 of the jackpot value 504 is defined, for example, by the operator of the electronic gaming system. Each gaming sequence performed at one or more of the electronic gaming devices 100a-100n contributes to an increase of the jackpot value 504 in increments, as shown by a reference numeral 509 representing an increment value. The current jackpot value J(t) thus is steadily increasing until a winning condition is fulfilled.

The determination of the jackpot value J(t) within a trigger value range 507 and the calculation of the hit value range 506 is described below.

According to an example method for determining a winning player, the jackpot to be hit is determined independently from the history of gaming sequences of an electronic gaming device. A very secure system determines a jackpot hit event due to the fact that the jackpot hit event is individually generated by a random number for each electronic gaming device.

A Jackpot system used in the example embodiment is a progressive Jackpot system. Each credit played in an electronic gaming device increases the current jackpot value J(t), this function being a steady step function.

The current jackpot value J(t) as a function of the gaming sequence duration 510 is determined from equation (1):

$$J ( t ) = L + IP {\sum }_{100 a}^{100 n} {\sum }_{i = 0}^{T} TI \qquad equation ( 1 )$$

In equation 1, L is the lower limit 501 of the jackpot value 504, and IP is an increment percentage which can be adjusted by the operator. The increment percentage is multiplied by a sum defined by a summation over time, i.e. t=0 to T and the respective electronic gaming devices contributing the jackpot value, i.e. a summation total input fund (TI) from an electronic gaming device 100a to an electronic gaming device 100n. The function of equation (2) is limited by the lower limit 501 and the upper limit 502. The jackpot value to be hit is specified to lie in the range between these limits.

The ranges relevant for a determination of a winning condition are a trigger value range (r1) and a hit value range (r2). The trigger value range can be determined by the trigger value range determination unit 114; the hit value range can be determined by the hit value range determination unit 112.

The trigger value range 507, i.e. a range defined as a difference between the upper limit 502 and the current jackpot value J(t) is defined by equation (2). In equation 2, U represents the upper limit 502 and r1 represents the trigger value range 507.
r1=U−J(t) equation (2)

The hit value range 506 defined by the difference between a reference value 505 and the current jackpot value J(t) is set according to equation (3). In equation 3, R(t) is the reference value 505 (see also FIG. 3), and r2 is the hit value range 506.
r2=R(t)−J(t) equation (3)

As depicted by equation 4, the time dependent reference value R(t) , which can be set by unit 116, is defined by the current jackpot value J(t) and the increment percentage IP, multiplied by an amount M which is defined as the lowest amount of money required for the gaming sequence within the electronic gaming system, i.e. the smallest possible bet within the electronic gaming system.
R(t)=J(t)+IP*M equation (4)

After having performed a specific gaming sequence, a player has contributed a certain amount to the jackpot value J(t). A random value generator for generating a random value 508 within the specified trigger value range 507 generates a random number within range r1. Random numbers are numbered that are occurring in a sequence such that two conditions are met: (i) the random values are uniformly distributed over a time interval; and (ii) it is impossible to predict future values based on past values or present values.

The methodology and the quality of the random number generator is essential for the distribution of values of the jackpot system.

Briefly, the calculation procedure comprises the following steps:
a) determining the current jackpot value J(t);
b) determining the hit value range 506 (r2);
c) generating a random value 508 within the trigger value range 507 (r1) (see FIG. 3);
d) determining, whether or not the random value 508 generated by means of the random value generator is within a specified hit value range 506; and
e) monitoring a hit event condition.

It is possible to combine electronic gaming devices 100a-100n having different denominations (i.e. different relations between gaming units and currency units). For a jackpot calculation procedure each bet is broken down into the lowest money unit M played in the system.

A number m of calculation procedures is defined by the amount of money played in a specific gaming sequence TI(t) divided by the lowest money unit M. According to the equation (5):

$$m = \frac{TI ( t )}{M} \qquad equation ( 5 )$$

The determination of the current jackpot value J(t) in the generation of a random value 508 by means of the random value generator and a comparison of the specific values is carried out m times per gaming sequence performed in an electronic gaming device 100a-100n. Thus, the current jackpot value J(t) may be estimated according to equation (6):

$${J}_{m} ( t ) = J ( t ) + {\sum }_{1}^{i = m} {M}_{i} \cdot IP \qquad equation ( 6 )$$

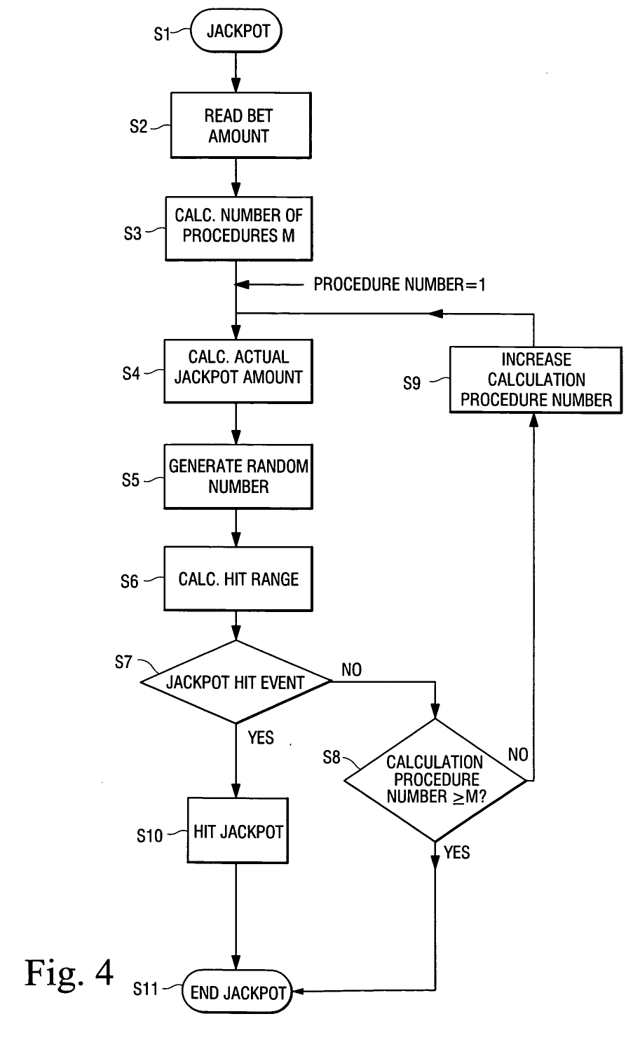

FIG. 4 gives a detailed flowchart of the gaming sequence according to the above equations. In step S1 a current jackpot is given. In step S2 a bet amount is read by the electronic gaming system 100a-100n. The process proceeds to step S3 where the number m of procedures to be performed is determined according to equation (5). The process starts with a procedure number m=1 in step S4 where a current jackpot value J(t) is calculated. In the next step S5 a random value 508 is generated using the random value generator of the electronic gaming system. Then the process proceeds to step S6 where a hit value range 506 is calculated according to equation (3).

In step S7 it is determined whether or not a jackpot hit event occurs, i.e. whether or not the random value 508 generated by means of the random value generator is within the hit value range 506. If the random value 508 is within the hit value range 506 (YES in step S7), a hit jackpot event is displayed (in step S10) and the electronic gaming device 100a-100n operated by the winning player is stopped while a jackpot payout procedure may be performed. Then the process ends at step S11.

However, when it is determined at step S7 that the random value 508 generated by means of the random value generator is not within the hit value 506 (NO in step S7), the process proceeds to step S8 where it is determined, whether or not the number m of procedures calculated by equation (5) (step S3) has been reached.

If it is determined in step S8 that the total number of procedures calculated in equation (5) (step S3) has not been reached (NO in step S8) the process proceeds to step S9 where the procedure number is incremented by one. Then the process returns to the beginning of step S4 and the steps S5 to S7 are repeated.

If it is determined in step S8, however, that the procedure number defined by equation (5) has been reached (YES in step S8) the process is stopped at step S11.

If a procedure number larger than one (m>1) is used, the current jackpot value is calculated according to equation (6):

$${J}_{m} ( t ) = J ( t ) + {\sum }_{1}^{i = m} {M}_{i} \cdot IP \qquad equation ( 6 )$$

As an example of a gaming sequence according to an example embodiment, it is assumed that an electronic gaming system consists of 100 electronic gaming devices 100a-100n (n=100), wherein 20 electronic gaming devices A have a credit unit of 20 Euro, 50 electronic gaming devices B have a credit unit of 1 Euro, 20 electronic gaming devices C have a credit unit of 10 Euro, and 10 electronic gaming devices D have a credit unit of 100 Euro.

The lowest money unit M of all electronic gaming devices connected to the electronic gaming system is 1 Euro, thus M=1 Euro. A reference value R(t) is calculated as a value which is added to the current jackpot value J(t) as a lowest money unit (M=1 Euro) times an increment percentage IP which is defined by the operator (site operator) of the electronic gaming system.

For example, for a game 1 performed at the time t at the electronic gaming device A with a total amount of money TI(t) of 2 credits of 20 Euro each, in total 40 Euro, the number of calculation procedures m is 40, because the lowest money unit M is 1 Euro.

For the game 2 performed at the time t at the electronic gaming device C with a total amount of money TI(t) of 1 credit of 1 Euro each, in total 1 Euro the number of calculation procedures m is 1, because the lowest money unit M is 1 Euro.

For a game 3 performed at the time t at the electronic gaming device D with a total amount of money TI(t) of 3 credits of 100 Euro each, in total 300 Euro, the number of calculation procedures m is 300, because the lowest money unit M is 1 Euro.

The above calculation procedure is performed for each electronic gaming device 100a-100n for m times for each gaming sequence being performed.

The lower limit 501 and the upper limit 502 can be limits of the jackpot value 504 as in the embodiment mentioned above. Furthermore, the lower and upper limits 501 and 502, respectively can be defined as time limits and/or local (site) limits.

The current jackpot value J(t) is calculated after each gaming sequence at the end of the respective gaming sequence. As the data are stored in the memory units 103 of the respective data management device 101a-101n within the respective electronic gaming device 100a-100n the current jackpot value J(t) can immediately be provided for other data management devices 101a-101n, within the other electronic gaming devices 100a-100n connected in the electronic gaming system via the databus device 201.

Treating the gaming data using decentralized data management devices within the electronic gaming devices permits smaller communication band widths since data are processed at the location where they are generated, resulting in less computing power correlated to the communication bandwidth and in a total redundancy due to a data storage in each data management device within each electronic gaming device.

It is an advantage of that a jackpot hit event can be selected remotely by the data management device in cooperation with two or more data management devices within electronic gaming devices.

Furthermore, the security of the electronic gaming system is enhanced due to the fact that a jackpot hit event is individually generated for each electronic gaming device by a random number. Furthermore, it is an advantage the inventive method for determining a jackpot can be performed at a central location or in a decentralized manner at the location of one or more data management devices within the electronic gaming devices of the electronic gaming system. A centralized operation requires additional communication bandwidth due to the high data rates for transferring gaming data.

A specific advantage is the possibility to calculate the jackpot system at decentralized locations.

A jackpot calculation procedure is performed in one or more data management devices within the electronic gaming devices after each game and before the following game, in a decentralized manner.

It is preferred that each electronic gaming device connected in the network can participate in modifying the jackpot value.

It is thus a specific advantage that the gaming data, e.g. audit data, do not have to be communicated to a central location where they are processed thus requiring that they are communicated back, but that they can be processed and calculated at the location where they are generated resulting in reduced communication and transmission rates. Due to the reduced transmission rates a computing power may be reduced.

Furthermore, it is an advantage that the hit values, i.e. the amounts of money of the hits, between a lower value (base value) and a higher value (top value) is equal due to a specific calculation procedure. This means that a total bet per game is advantageously subdivided by the lowest amount of money required for the gaming sequence within the electronic gaming system, i.e. the smallest bet within the electronic gaming system. These subdivisions for the calculation of the jackpot amount lead to balanced amounts of money for the respective jackpot hits.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

Furthermore the invention is not limited to the specific application areas mentioned above.

List of Reference Numerals

100 Electronic gaming device
101 Data Management device
102 Processor unit
103 Memory unit
104 Communication device
105 Output unit
106 Input unit
107 User interface unit
108 Hit event detection unit
110 Protocol Detector
112 Hit Range Determination Unit
114 Trigger Value Determination Unit
116 Reference Value Setting Unit
201 Databus device
202 Database management device
203 Protocol detection unit
501 Lower limit
502 Upper limit
503 Restart range
509 Jackpot value
505 Reference value, R(t)
506 Hit value range
507 Trigger value range
508 Random value
509 Increment value
510 Gaming sequence duration

1. An electronic gaming system, comprising:
a plurality of interconnected data management devices within a respective plurality of electronic gaming devices;
a databus device for connecting the plurality of data management devices;
a random value generator for generating a random value within a specified trigger value range;
wherein one or more of said data management devices comprise:
a Jackpot detection unit for detecting, in a decentralized manner, a current Jackpot value after each gaming sequence; and
a hit event detection unit for determining, in a decentralized manner, whether or not the random value generated by the random value generator is within a specified hit value range.

2. A system according to claim 1, further comprising a hit value range determination unit for determining a hit value range to indicate a gaming sequence winning condition, if the random value generated by means of the random value generator is within the hit value range.

3. A system according to claim 1, further comprising a trigger value range determination unit for determining a trigger value range from a difference between an upper limit of the Jackpot value and the current Jackpot value.

4. A system according to claim 1, further comprising a reference value setting unit for setting a reference value in dependence of the current Jackpot value and an increment value.

5. A system according to claim 4, further comprising a hit value range determination unit for determining the hit value range from a difference between the reference value and the current Jackpot value.

6. A system according to claim 1, wherein each data management device comprises:
a processor unit for processing gaming data generated in the respective electronic gaming device in response to a gaming sequence being performed using the electronic gaming device;
a memory unit for storing gaming data generated in the gaming device ; and
a communication device for communicating gaming data with at least one other data management device within the other electronic gaming device of said electronic gaming system.

7. A system according to claim 6, wherein the databus device connects the plurality of data management devices with each other by means of the communication devices provided in each of the data management devices for exchanging gaming data between said data management devices of said electronic gaming system.

8. A system according to claim 6, wherein the gaming data comprise static data and/or dynamic data.

9. A system according to claim 8, wherein the static data includes one or more of position related data, parameters of the electronic gaming device, denomination data, maximum-bet data, payout percentage data, serial numbers, game identification data, paytable identification data, bill country and game number data.

10. A system according to claim 8, wherein the dynamic data includes one or more of site configuration data, jackpot configuration data and audit data.

11. A system according to claim 6, wherein the memory units of the data management devices are designed to store identical data.

12. A system according to claim 6, further comprising an operator terminal connected to the databus device for controlling and monitoring one or more of said electronic gaming devices.

13. A method for monitoring a plurality of gaming devices interconnected by the means of data management devices in an electronic gaming system, the method comprising:
generating a random value within a specified trigger value range;
detecting a current Jackpot value, in a decentralized manner at one or more of the data management devices, after a gaming sequence has been performed in one or more of the electronic gaming devices ; and
determining, in a decentralized manner at the one or more of the data management devices, whether or not the random value is within a specified hit value range.

14. A method according to claim 13, further comprising determining a gaming sequence winning condition when the random value generated by means of the random value generator is within the hit value range.

15. A method according to claim 13, further comprising determining the trigger value range from a difference between an upper limit of the Jackpot value and the current Jackpot value.

16. A method according to claim 13, further comprising setting a reference value in dependence of the current Jackpot value and an increment value.

17. A method according to claim 13, further comprising each gaming sequence performed at one or more of the electronic gaming devices contributing to an increase of the Jackpot value.

18. A method according to claim 15, further comprising the operator of the electronic gaming system defining the lower limit and/or the upper limit of the jackpot value.

19. A method according to claim 13, further comprising each gaming sequence performed at one or more of the electronic gaming devices located in different sites contributing to an increase of the Jackpot value.

20. A method according to claim 13, further comprising
processing gaming data generated in an electronic gaming device in response to a gaming sequence being performed using the gaming device by means of a processor unit provided in the data management device;
storing gaming data generated in the electronic gaming device in a memory unit provided in the data management device;
communicating gaming data with at least one other data management device of said electronic gaming system by means of a communication device provided in the data management device;
storing said gaming data of said other electronic gaming device in the memory unit of the data management device by means of the processor unit; and
processing gaming data stored in said memory unit by the processor unit of the data management device.
